(19) United States
(12) Patent Application Publication
(10) Pub. No.: US 2009/0284975 A1
(43) Pub. Date: Nov. 19, 2009

(54) Lighting Device With Magnetic Attraction System for Orienting the Light Beam

(76) Inventor: Lorenzo Querci, Firenze (IT)

Correspondence Address: POLLACK, P.C., THE CHRYSLER BUILDING, 132 EAST 43RD STREET, SUITE 760, NEW YORK, NY, 10017, US

(21) Appl. No.: 12/085,917

(22) PCT Filed: May 17, 2007
(86) PCT No.: PCT/IB2007/051893

§ 371 Date: May 30, 2008

(30) Foreign Application Priority Data
May 31, 2006 (IT) FI2006A000135

(51) Int. Cl. F21V 19/02

(52) U.S. Cl. 362/285; 362/372

(57) ABSTRACT

A lighting device which comprises a box-shaped body and a light source in the body, with at least one wall that allows passage of a light beam generated by the light source. The box-shaped body includes a pivotable support mounting the light source such that it is rotatable about at least one axis of rotation for adjusting the angle of the light beam generated thereby. The device also has a magnetic attraction member for controlling the axis from the outside the body.

### FIELD OF THE INVENTION

The present invention relates generally to the field of lighting appliances and particularly to a lighting device, especially but not exclusively of the type intended for flush mounting in floors, in which the light beam is orientable.

### BACKGROUND ART

In certain situations it may be necessary for the direction of the light beam produced by a lighting appliance to be adjustable according to need. For such purposes, there are known devices wherein the orientation of the light beam is obtained by rotating the entire lamp body, which is pivotally connected to its base. Since a solution of this type is not always acceptable or feasible, alternative lighting devices have been proposed wherein the assembly of the body is fixed while the light source is installed on a support which allows for it to rotate. However, the rotation of the support to change the orientation of the light beam may pose some problems.

In fact, adjusting the inclination of the light source involves dismantling the lighting appliance to gain access to its interior in order to take action manually on the lamp base. Dismantling the glass cover protecting the lamp may prove particularly laborious, especially in the case of flush-mounted, watertight lighting appliances of the type often needed for installation in outside environments, e.g. along paths leading to the door of a home, or in interiors with a high degree of humidity, such as kitchens or bathrooms. The watertight feature of the appliance may also be lost due to wear on the sealing gaskets deriving from repeated dismantling, or due to an erroneous re-assembly of said sealing gaskets.

On the other hand, the provision for a mechanical transmission of the beam-adjusting action accessible from outside the device to avoid the need for said dismantling procedure would not only be functionally and aesthetically unacceptable, but would also be unsuitable for use in watertight flush-mounted appliances because of the consequent risk of infiltration around the area of the operating element of transmission.

The object of the present invention is to provide a lighting device with a fixed lamp body installation in which the direction of the light beam can be adjusted without the need to dismantle the device.

Another object of the present invention is to provide a lighting device of the above-mentioned type wherein the light beam can be adjusted using a structurally and functionally straightforward solution without affecting the appearance of the device.

### SUMMARY OF THE INVENTION

These objects are achieved with the lighting device according to the present invention, which comprises a box-shaped body and a light source housed in the body, said body having at least a wall through which a light beam generated by the light source is emitted. The body contains a pivotable lamp base whereon the light source is mounted so that it is capable of rotating around at least one axis of rotation in order to adjust the orientation of the light beam projected therefrom. Means exerting an attractive magnetic force are provided to enable the base to be rotated around the axis of rotation from the outside of the box, in particular operated through a cursor sliding along guide means fixedly attached to the body, and capable of displacement in a direction parallel to the light emission wall and at right angles to the axis of rotation of the lamp base. The cursor is connected to the base so that the displacement of the cursor and the rotation of the base are cinematically linked and means are provided for reversibly locking the position of the cursor which comprises an element responsive to attractive magnetic forces such that movable control means exerting an attractive magnetic force from the outside of the box-shaped body can be used to command the release of the locking means and the displacement of the cursor with a consequent rotation of the light source.

### BRIEF DESCRIPTION OF THE DRAWINGS

The characteristics and advantages of the lighting device according to the present invention will be apparent from the following description of an embodiment thereof, provided as a non-limiting example with reference to the attached drawings, wherein:

FIG. 1 shows a perspective view of the internal structure of a lighting device according to the present invention;

FIG. 2 shows a plan view of the lighting device according to the present invention;

FIG. 3 shows a cross-sectional view of the lighting device taken along lines III-III in FIG. 2;

FIGS. 4a and 4b show cross-sections of the lighting device taken along lines IV-IV of FIG. 2, in two different stages of the operating procedure.

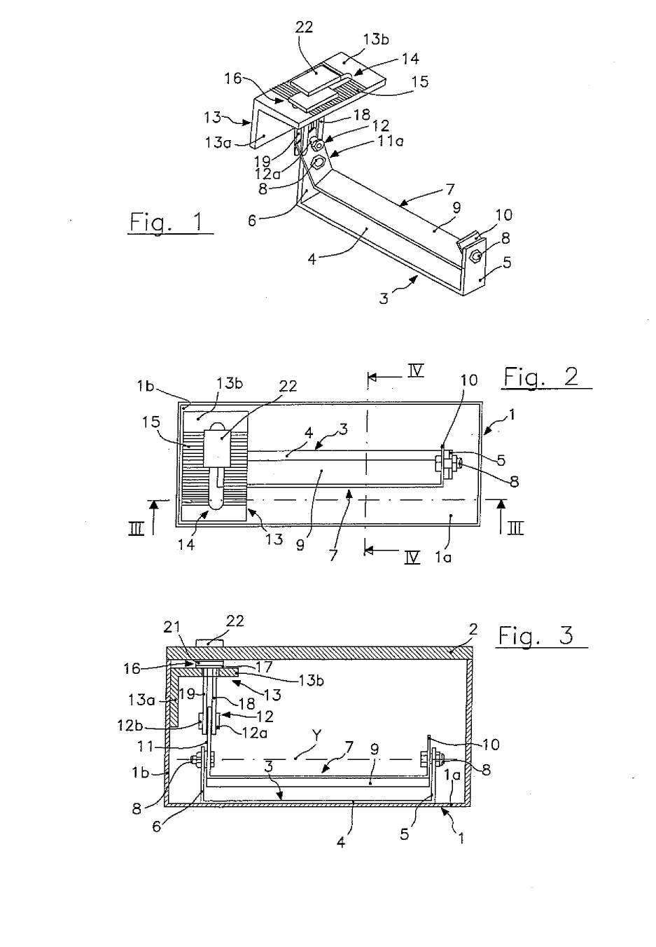

### DETAILED DESCRIPTION OF THE INVENTION

With reference to the aforementioned figures, the embodiment described below concerns a flush-mounted watertight floor lighting device—an installation that represents a preferred, but not exclusive application of the invention. The numeral 1 is used to indicate a box-shaped body of substantially parallelepiped shape, intended for flush mounting in a corresponding seat (not shown) formed in a floor or, more in general, in a substantially horizontal floor surface. The body 1 is open on its upper side, i.e. on the side lying flush with the floor after the appliance has been installed. A protective glass cover 2 is arranged on the open side, serving as a lid that closes the body 1. The watertightness of the closure is assured by means of sealing gaskets (not shown) attached in line with the contact surfaces between the body 1 and the glass cover 2.

On the bottom la of the body 1, i.e. on the side opposite the one formed by the glass cover 2, there stands a fixed supporting element 3 consisting of an elongated base 4 attached to bottom 1a, with two arms 5, 6, one at each end, projecting at right angles therefrom. The arms 5, 6 define the extremities of an axis Y, parallel to the bottom 1a and a pivotable support 7 is pivotally connected to said arms by means of bolted connection means 8 for rotation around axis Y.

In particular, the pivotable support 7 comprises a base 9 of similar shape to that of the base 4 of the fixed supporting element 3, and arms 10, 11 at each end bent back at right angles to said base 9. The connection means 8 hold the latter arms 10, 11 up against the respective inner surfaces of the arms 5, 6 of the fixed supporting element 3. A light source (not shown) is installed on the base 9 with the aid of electrically-powered supporting means of conventional type (not shown).

One of the two arms of the pivotable support 7, i.e. the one indicated by the numeral 11 in the example, extends further beyond the corresponding bolted connection than the other arm, thereby defining the operating end 11a, to which there is fixed a cylindrical stud 12 on an axis parallel to the axis of rotation Y. The stud 12 has two sections, 12a and 12b, projecting symmetrically from either side of the end 11a.

A guide 13 is attached to a side wall 1b of the body 1, so that it lies parallel and adjacent to the arms 6 and 11; in the embodiment illustrated, the guide is in the form of square-shaped element with a first wing 13a fixed to the side wall 1b and a second wing 13b extending parallel and proximal to the glass cover 2, projecting over the operating end 11a of the arm 11.

A slot 14 is cut in the second wing 13b in the direction perpendicular to the axis Y and exactly in line with the operating end 11a of the arm 11. The upper face of the second wing 13b, i.e. the surface facing towards the glass cover 2, has a toothed surface 15 formed by a plurality of adjacent teeth that develop lengthwise in a direction perpendicular to the slot 14.

A cursor 16 engages slidingly with the slot 14 and comprises a plate 17 resting on the upper face of the wing 13b and two forks 18 and 19 projecting downwards from the plate 17 to fit into the slot 14. Each fork 18(19) defines a slit 24 in which respectively engage slidingly one of the two sections 12a, 12b of the stud 12 provided on the operating end 11a of the arm 11. To this purpose, the two forks are spaced from one another so as to house end 11a in the space defined therebetween.

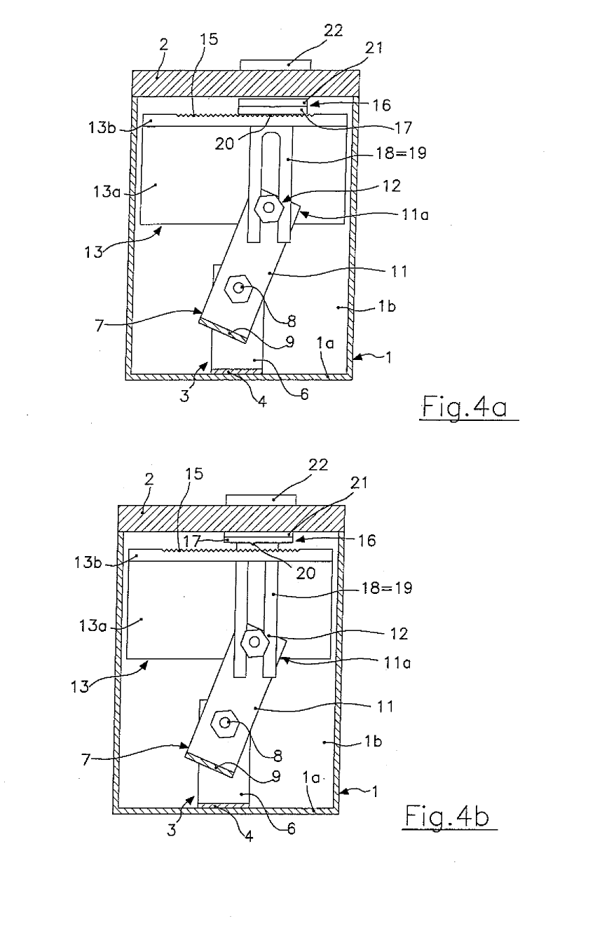

A locking tooth 20 (shown in FIGS. 4a and 4b) projects from the underside of the plate 17 so as to engage between two adjacent teeth in the toothed surface 15 to prevent the cursor 16 from sliding with respect to the guide 13. A sheet plate 21 of ferromagnetic material is firmly attached to the upper surface of the plate 17.

With particular reference to FIGS. 4a and 4b, the appliance according to the present invention operates as follows. The orientation of the light beam in a given direction is achieved by taking action from the outside of the device on the movable support 7, on which the light source is installed.

FIG. 4a shows any stable configuration of the device, with a given orientation of the light beam stably maintained by the engagement of the locking tooth 20 between two adjacent teeth on the toothed surface 15. Starting from said configuration, in order to change the inclination of the pivotable support 7, it is necessary to disengage the locking tooth 20 from the toothed surface 15. To do so, action is taken with a magnet 22 placed on the outer surface of the glass cover 2, in a position corresponding to the cursor 16, with an attractive magnetic force sufficient to lift the cursor 16, thereby disengaging the locking tooth 20 from the toothed surface 15.

Then any displacement of the magnet 22 over the glass cover 2 in a direction parallel to the slot 14 gives rise to a simultaneous displacement of the cursor 16. The two sections 12a, 12b of the stud 12 being respectively engaged with the forks 18 and 19, any displacement of the forks induces a rotation of the pivotable support 7 (to which the stud 12 is attached) around the axis Y, with a consequent change in the inclination of the light beam. The length of the slot 14 determines the end angular positions that can be occupied by the pivotable support 7.

When the inclination of the light beam coincides with the user's requirements, the magnet 22 is lifted away from the glass cover 2, preferably in a movement perpendicular to the surface of the glass to prevent any accidental further displacement from modifying the set light beam orientation. When the magnet 22 is withdrawn, the action of its attractive magnetic force on the cursor 16 is lost and, due to the effect of gravity, the latter drops back onto the wing 13b of the guide 13, restoring the stability of its new position when the locking tooth 20 engages between two adjacent teeth on the toothed surface 15.

Any further modification of the angle of the light beam can be achieved by placing the magnet 22 back on the glass cover 2 and repeating the previously-described procedure.

It is clear from the above description that the device according to the invention enables the orientation of the light beam to be adjusted without the need to undertake any dismantling operation and without using any mechanical transmission system connecting the inside with the outside of the device. The reliability of the watertightness, in the case of a watertight device, is consequently assured, together with a solution that is functionally straightforward and safe, and that does not affect the structural appearance of the device.

The exploitation of a force of magnetic attraction between an outside control element and an inside element (a magnet and a ferromagnetic element, or two magnets of opposite polarity) to induce a rotation of the pivotable support for the light source may also rely on different structural solutions from the one described in the embodiment illustrated herein, though the latter has the advantage of being simple to manufacture and reliable in operation.

The previously-described embodiment shall not be deemed to restrict the potential applications of the invention. In particular, lighting appliances installed on vertical walls or ceilings, be they for flush mounting or otherwise, may also benefit from such a solution using an attractive magnetic force to modify the orientation of a pivotable support for a light source. The support's axis of rotation may also be in any arrangement other than the horizontal. Where necessary, elastic means may be used to exert a return action in lieu of the effect of gravity in floor lighting installations. Even more in general, the pivotable support may also be capable of rotation around two or three axes, always under the control of operating means exploiting an attractive magnetic force.

Still in the context of structural solutions that can be traced back to the preferred embodiment, the engagement between the stud 12 and the arm 11 may include different structural expedients, e.g. instead of the forks 18 and 19, an arm projecting downwards from the plate 17, with a stud fixed to the free end of said arm suitable for engaging slidingly in a slit obtained on the operating end 11a of the arm 11. Different structural solutions may also be adopted for the configuration of the plate 17 and of the corresponding supporting and locking system.

Various modifications and alterations to the invention may be appreciated based on a review of the disclosure. These changes and additions are intended to be within the scope and the spirit of the invention as defined by the following claims.

1. A lighting device which comprises a box-shaped body, a light source in the body, at least one wall of which enables passage of a light beam generated by the light source, a pivotable support being provided inside the body for mounting the light source such that it is rotatable about at least one axis of rotation to change the angle of the light beam generated by the light source, the device further comprising a magnetic attraction member for inducing rotation of the support about the axis from outside the box-shaped body.

2. The device set forth in claim 1, wherein the body houses a cursor for sliding along a guide mounted securely to the body so as to be displaceable in a direction generally parallel to the wall through which the light beam is projected and substantially at right angles to the axis of rotation, the cursor being joined with the support such that displacement of the cursor and rotation of the support are cinematically linked, a device also being provided, between the cursor and the guide, for reversibly locking the cursor—and consequently also the pivotable support—in a selected position, the cursor having an element responsive to the force of magnetic attraction, so that a movable controller exerting an attractive magnetic force on the outside of the body may control release of the locking device and displacement of the cursor along the guide, and corresponding angular displacement of the pivotable support and of the light source.

3. The device set forth in claim 2, wherein the axis of rotation is relatively parallel to the wall through which the light beam is projected and a bottom portion of the body, opposite the light-projecting wall, the pivotable support comprising an operating arm projecting radially from the axis of rotation toward the light-projecting wall, the cursor engaging the operating arm through a stud slidingly coupled inside a slit of the cursor.

4. The device set forth in claim 3, wherein the cursor includes a fork-shaped member projecting towards the bottom portion at right angles to the light-projecting wall and defining the slit, engaging a stud projecting from the operating arm of the support.

5. The device set forth in claim 4, wherein the fork-shaped member comprises a pair of mutually spaced forks, the operating arm extending therebetween, the stud of the operating arm having two opposing symmetrical portions projecting on either side for engaging the respective forks.

6. The device set forth in claim 2, wherein the guide has a wing projecting from a side wall of the box-shaped body and generally parallel to the light-projecting wall, and a slot for the cursor formed on the wing, the cursor further comprising a plate which rests on the wing.

7. The device set forth in claim 6, wherein the locking device includes a toothed surface with adjacent teeth formed on the wing, lying generally perpendicular to the slot, and at least one locking tooth extending downwardly from the plate to engage between two adjacent teeth on the toothed surface.

8. The device set forth in claim 3, wherein the pivotable support comprises a base for mounting the light source and arms at each end, one of which is the operating arm, bent at generally right angles to the base and pivotally connected to respective arms rising from the bottom portion.

9. The device set forth in claim 1, wherein the body is watertight.

10. The device set forth in claim 7, wherein the plate is retained by gravity or by an elastic force in a locked position on the toothed surface.

11. The device set forth in claim 1, wherein the support can pivot two axes of rotation lying at generally right angles to one another, complete with different operating magnetic attraction members.

12. The device set forth in claim 1, wherein the support pivots about an axis at generally right angles to the light-projecting wall.
